(19) United States
(12) Patent Application Publication
(10) Pub. No.: US 2017/0205675 A1
(43) Pub. Date: Jul. 20, 2017

(54) ARRAY SUBSTRATES AND LIQUID CRYSTAL DEVICES

(71) Applicant: Shenzhen China Star Optoelectronics Technology Co. Ltd., Shenzhen, Guangdong (CN)

(72) Inventors: Cheng-hung CHEN, Shenzhen, Guangdong (CN); Jiali JIANG, Shenzhen, Guangdong (CN)

(73) Assignee: Shenzhen China Star Optoelectronics Technology Co., Ltd., Shenzhen, Guangdong (CN)

(21) Appl. No.: 14/894,491

(22) PCT Filed: Oct. 21, 2015
(86) PCT No.: PCT/CN2015/092360

§ 371 Date: Nov. 27, 2015

(30) Foreign Application Priority Data
Sep. 30, 2015 (CN) 201510640785.3

(51) Int. Cl. G02F 1/1362; G02F 1/1343; G02F 1/1368

(52) U.S. Cl. CPC G02F 1/136286; G02F 1/1368; G02F 1/134336; G02F 2201/123; G02F 2201/121

(57) ABSTRACT

An array substrate includes a plurality of pixels arranged in a matrix, at least one voltage transmission block arranged in all of pixels or a portion of the pixels, and common voltage wirings. The voltage transmission block is configured for transmitting a grayscale voltage received by a pixel electrode within the pixel where the voltage transmission block is located to the common voltage wirings. A plurality of grayscale voltages transmitted to the common voltage wirings cooperatively forms a common voltage. In addition, a LCD includes the above array substrate is also disclosed. In this way, the optimal common voltage may be obtained such that the display performance is guaranteed.

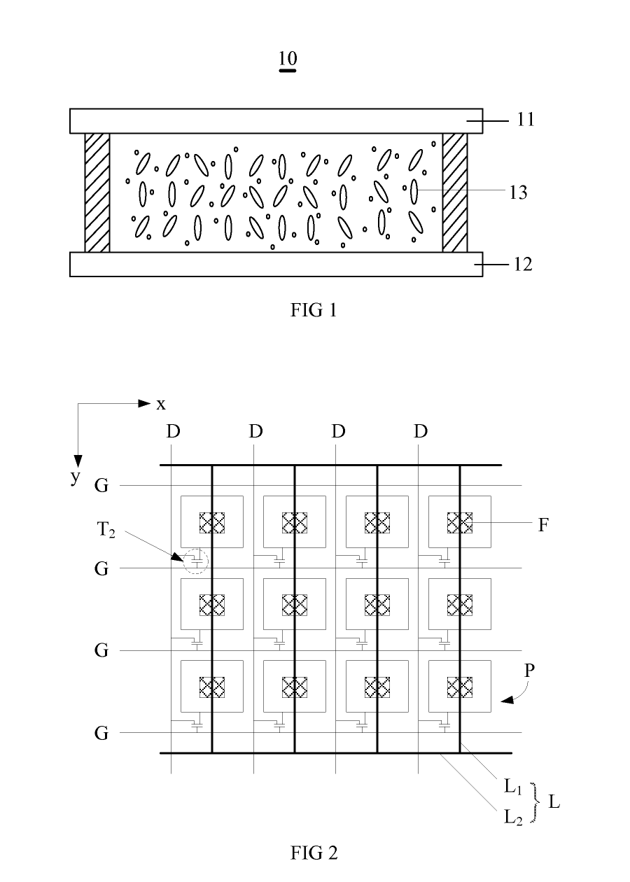

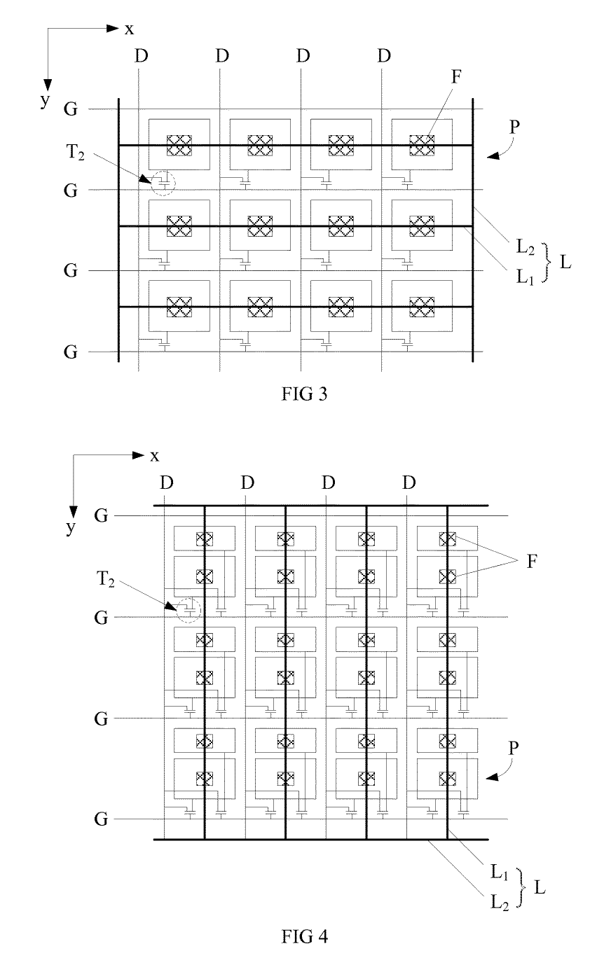

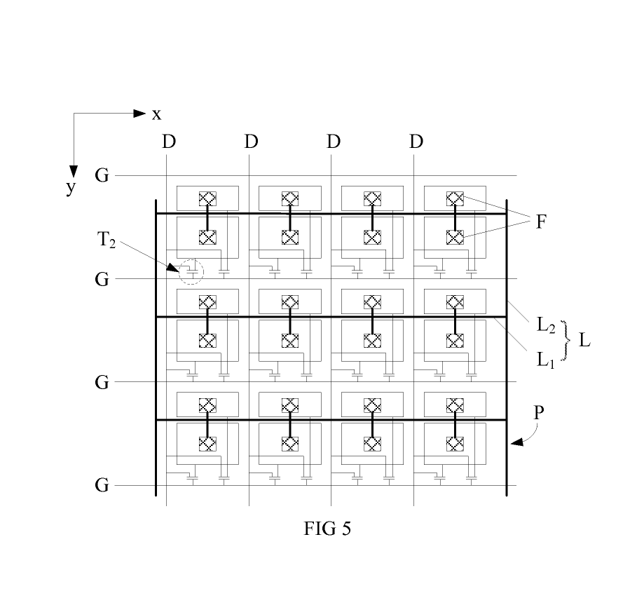

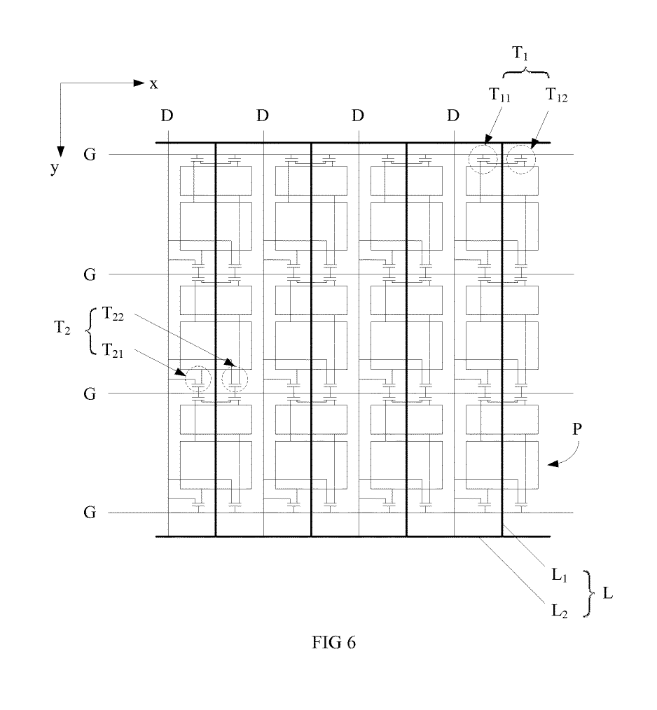

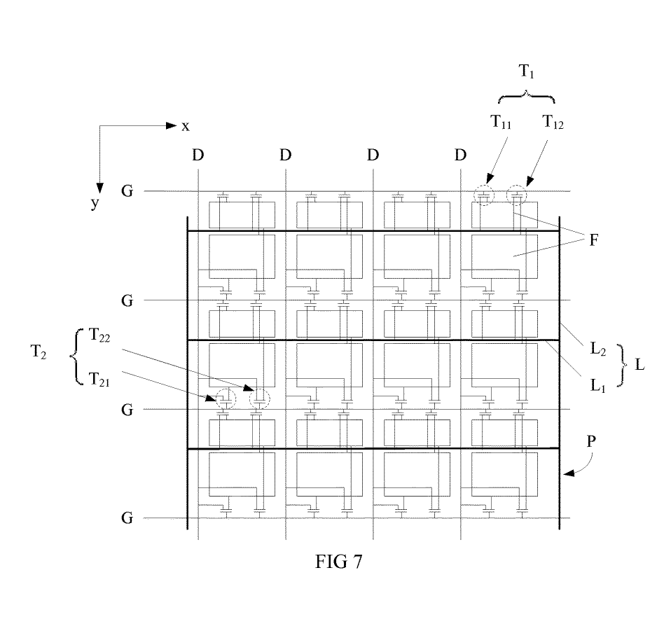

### BACKGROUND OF THE INVENTION

1. Field of the Invention

The present disclosure relates to display technology, and more particularly to an array substrate and a liquid crystal device (LCD).

2. Discussion of the Related Art

With the technology development, the liquid crystal device (LCD) has been widely adopted as display devices. Usually, the voltage difference between the common electrode and the pixel electrode plays an important role with respect to the display performance. For instance, abnormal voltage difference may cause defects in the displayed grayscale, which is called as color shift. The grayscale voltage received by the pixel electrode is obtained by the alternated signals provided by the data lines, and the common voltage received by the common electrode is received by the wirings of the common voltage. However, as the voltage coupling may exist between the data line and the wirings of the common voltage, the common voltage may not achieve an optical threshold, which may result in color shift issue so as to affect the display performance.

### SUMMARY

The object of the invention is to provide an array substrate and a liquid crystal device (LCD) for adjusting the common voltage adaptively so as to ensure the display performance.

In one aspect, an array substrate includes: a plurality of pixels arranged in a matrix, at least one voltage transmission block arranged in all of pixels or a portion of the pixels, and common voltage wirings, the voltage transmission block is configured for transmitting a grayscale voltage received by a pixel electrode within the pixel where the voltage transmission block is located to the common voltage wirings, a plurality of grayscale voltages transmitted to the common voltage wirings cooperatively forms a common voltage, wherein the voltage transmission block includes one thin film transistor (TFT), a gate of the TFT connects to a selectively turn-on line, and one of a source and a drain connects to the pixel electrode within the pixel, and the other one connects to the common voltage wirings, and the selectively turn-on line is a scanning line at a previous level corresponding to the pixel where the voltage transmission block is located.

Wherein the array substrate further includes a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the first direction and at least one second common voltage wirings, each of the second common voltage wirings is parallel to the first direction, the at least two second common voltage wirings are spaced apart from each other along the second direction, each of the first common voltage wirings connects with the voltage transmission blocks arranged along the second direction, and the second common voltage wirings connect with the plurality of first common voltage wirings.

Wherein the array substrate further includes a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the second direction and at least one second common voltage wirings, each of the second common voltage wirings is parallel to the second direction, the at least two second common voltage wirings are spaced apart from each other along the first direction, each of the first common voltage wirings connects with the voltage transmission blocks arranged along the first direction, and the second common voltage wirings connect with the plurality of first common voltage wirings.

In another aspect, an array substrate includes: a plurality of pixels arranged in a matrix, at least one voltage transmission block arranged in all of pixels or a portion of the pixels, and common voltage wirings, the voltage transmission block is configured for transmitting a grayscale voltage received by a pixel electrode within the pixel where the voltage transmission block is located to the common voltage wirings, and a plurality of grayscale voltages transmitted to the common voltage wirings cooperatively forms a common voltage.

Wherein the voltage transmission block includes one TFT, a gate of the TFT connects to a selectively turn-on line, and one of a source and a drain connects to the pixel electrode within the pixel, and the other one connects to the common voltage wirings.

Wherein the selectively turn-on line is a scanning line at a previous level corresponding to the pixel where the voltage transmission block is located.

Wherein the array substrate further includes a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the first direction and at least one second common voltage wirings, each of the second common voltage wirings is parallel to the first direction, the at least two second common voltage wirings are spaced apart from each other along the second direction, each of the first common voltage wirings connects with the voltage transmission blocks arranged along the second direction, and the second common voltage wirings connect with the plurality of first common voltage wirings.

Wherein the array substrate further includes a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the second direction and at least one second common voltage wirings, each of the second common voltage wirings is parallel to the second direction, the at least two second common voltage wirings are spaced apart from each other along the first direction, each of the first common voltage wirings connects with the voltage transmission blocks arranged along the first direction, and the second common voltage wirings connect with the plurality of first common voltage wirings.

Wherein each of the pixels includes at least two pixel areas, and one of the pixel areas is configured with the voltage transmission block, and the voltage transmission blocks within the same pixel connect to the same first common voltage wirings.

Wherein the voltage transmission block includes a first TFT, gates of the first TFTs within the same pixel row, along the first direction, connect to the scanning line at the previous level corresponding to the pixels where the voltage transmission blocks are located, one of the source and the drain of the TFT connects to the pixel electrode within the pixel electrode of the pixel where the voltage transmission block is located, and the other one connects to the corresponding first common voltage wirings.

Wherein the array substrate further includes a second TFT within each of the pixels, gates of the second TFTs within the same pixel row, along the first direction, connect to the corresponding scanning line of the pixel where the voltage transmission block is located, and one of the source and the drain connects to the corresponding data line, and the other one connects to the pixel electrode within the corresponding pixel.

In another aspect, a liquid crystal device (LCD) includes: a color filter substrate and an array substrate opposite to the color filter substrate, the array substrate includes a plurality of pixels arranged in a matrix, at least one voltage transmission block arranged in all of pixels or a portion of the pixels, and common voltage wirings, the voltage transmission block is configured for transmitting a grayscale voltage received by a pixel electrode within the pixel where the voltage transmission block is located to the common voltage wirings, a plurality of grayscale voltages transmitted to the common voltage wirings cooperatively forms a common voltage.

Wherein the common voltage formed within the array substrate is transmitted to the color film substrate via the common voltage wirings.

Wherein the voltage transmission block includes one thin film transistor (TFT), a gate of the TFT connects to a selectively turn-on line, and one of a source and a drain connects to the pixel electrode within the pixel, and the other one connects to the common voltage wirings.

Wherein the selectively turn-on line is a scanning line at a previous level corresponding to the pixel where the voltage transmission block is located.

Wherein the array substrate further includes a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the first direction and at least one second common voltage wirings, each of the second common voltage wirings is parallel to the first direction, the at least two second common voltage wirings are spaced apart from each other along the second direction, each of the first common voltage wirings connects with the voltage transmission blocks arranged along the second direction, and the second common voltage wirings connect with the plurality of first common voltage wirings.

Wherein the array substrate further includes a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the second direction and at least one second common voltage wirings, each of the second common voltage wirings is parallel to the second direction, the at least two second common voltage wirings are spaced apart from each other along the first direction, each of the first common voltage wirings connects with the voltage transmission blocks arranged along the first direction, and the second common voltage wirings connect with the plurality of first common voltage wirings.

Wherein each of the pixels includes at least two pixel areas, and one of the pixel areas is configured with the voltage transmission block, and the voltage transmission blocks within the same pixel connect to the same first common voltage wirings.

Wherein the voltage transmission block includes a first TFT, gates of the first TFTs within the same pixel row, along the first direction, connect to the scanning line at the previous level corresponding to the pixels where the voltage transmission blocks are located, one of the source and the drain of the TFT connects to the pixel electrode within the pixel electrode of the pixel where the voltage transmission block is located, and the other one connects to the corresponding first common voltage wirings.

In the claims:

1. An array substrate, comprising:
a plurality of pixels arranged in a matrix, at least one voltage transmission block arranged in all of pixels or a portion of the pixels, and common voltage wirings, the voltage transmission block is configured for transmitting a grayscale voltage received by a pixel electrode within the pixel where the voltage transmission block is located to the common voltage wirings, a plurality of grayscale voltages transmitted to the common voltage wirings cooperatively forms a common voltage, wherein the voltage transmission block comprises one thin film transistor (TFT), a gate of the TFT connects to a selectively turn-on line, and one of a source and a drain connects to the pixel electrode within the pixel, and the other one connects to the common voltage wirings, and the selectively turn-on line is a scanning line at a previous level corresponding to the pixel where the voltage transmission block is located.

2. (canceled)

3. The array substrate as claimed in claim 1, wherein the array substrate further comprises a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the first direction and at least one second common voltage wirings, each of the second common voltage wirings is parallel to the first direction, the at least two second common voltage wirings are spaced apart from each other along the second direction, each of the first common voltage wirings connects with the voltage transmission blocks arranged along the second direction, and the second common voltage wirings connect with the plurality of first common voltage wirings.

4. The array substrate as claimed in claim 1, wherein the array substrate further comprises a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the second direction and at least one second common voltage wirings, each of the second common voltage wirings is parallel to the second direction, the at least two second common voltage wirings are spaced apart from each other along the first direction, each of the first common voltage wirings connects with the voltage transmission blocks arranged along the first direction, and the second common voltage wirings connect with the plurality of first common voltage wirings.

5. An array substrate, comprising:
a plurality of pixels arranged in a matrix, at least one voltage transmission block arranged in all of pixels or a portion of the pixels, and common voltage wirings, the voltage transmission block is configured for transmitting a grayscale voltage received by a pixel electrode within the pixel where the voltage transmission block is located to the common voltage wirings, and a plurality of grayscale voltages transmitted to the common voltage wirings cooperatively forms a common voltage.

6. The array substrate as claimed in claim 5, wherein the voltage transmission block comprises one TFT, a gate of the TFT connects to a selectively turn-on line, and one of a source and a drain connects to the pixel electrode within the pixel, and the other one connects to the common voltage wirings.

7. The array substrate as claimed in claim 5, wherein the selectively turn-on line is a scanning line at a previous level corresponding to the pixel where the voltage transmission block is located.

8. The array substrate as claimed in claim 5, wherein the array substrate further comprises a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the first direction and at least one second common voltage wirings, each of the second common voltage wirings is parallel to the first direction, the at least two second common voltage wirings are spaced apart from each other along the second direction, each of the first common voltage wirings connects with the voltage transmission blocks arranged along the second direction, and the second common voltage wirings connect with the plurality of first common voltage wirings.

9. The array substrate as claimed in claim 5, wherein the array substrate further comprises a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the second direction and at least one second common voltage wirings, each of the second common voltage wirings is parallel to the second direction, the at least two second common voltage wirings are spaced apart from each other along the first direction, each of the first common voltage wirings connects with the voltage transmission blocks arranged along the first direction, and the second common voltage wirings connect with the plurality of first common voltage wirings.

10. The array substrate as claimed in claim 5, wherein each of the pixels comprises at least two pixel areas, and one of the pixel areas is configured with the voltage transmission block, and the voltage transmission blocks within the same pixel connect to the same first common voltage wirings.

11. The array substrate as claimed in claim 5, wherein the voltage transmission block comprises a first TFT, gates of the first TFTs within the same pixel row, along the first direction, connect to the scanning line at the previous level corresponding to the pixels where the voltage transmission blocks are located, one of the source and the drain of the TFT connects to the pixel electrode within the pixel electrode of the pixel where the voltage transmission block is located, and the other one connects to the corresponding first common voltage wirings.

12. The array substrate as claimed in claim 10, wherein the array substrate further comprises a second TFT within each of the pixels, gates of the second TFTs within the same pixel row, along the first direction, connect to the corresponding scanning line of the pixel where the voltage transmission block is located, and one of the source and the drain connects to the corresponding data line, and the other one connects to the pixel electrode within the corresponding pixel.

13. A liquid crystal device (LCD), comprising:
a color filter substrate and an array substrate opposite to the color filter substrate, the array substrate comprises a plurality of pixels arranged in a matrix, at least one voltage transmission block arranged in all of pixels or a portion of the pixels, and common voltage wirings, the voltage transmission block is configured for transmitting a grayscale voltage received by a pixel electrode within the pixel where the voltage transmission block is located to the common voltage wirings, a plurality of grayscale voltages transmitted to the common voltage wirings cooperatively forms a common voltage.

14. The LCD as claimed in claim 13, wherein the common voltage formed within the array substrate is transmitted to the color film substrate via the common voltage wirings.

15. The LCD as claimed in claim 13, wherein the voltage transmission block comprises one thin film transistor (TFT), a gate of the TFT connects to a selectively turn-on line, and one of a source and a drain connects to the pixel electrode within the pixel, and the other one connects to the common voltage wirings.

16. The LCD as claimed in claim 13, wherein the selectively turn-on line is a scanning line at a previous level corresponding to the pixel where the voltage transmission block is located.

17. The LCD as claimed in claim 13, wherein the array substrate further comprises a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the first direction and at least one second common voltage wirings, each of the second common voltage wirings is parallel to the first direction, the at least two second common voltage wirings are spaced apart from each other along the second direction, each of the first common voltage wirings connects with the voltage transmission blocks arranged along the second direction, and the second common voltage wirings connect with the plurality of first common voltage wirings.

18. The LCD as claimed in claim 13, wherein the array substrate further comprises a plurality of data lines spaced apart from each other along a first direction, a plurality of scanning lines spaced apart from each other along a second direction, the first direction is orthogonal to the second direction, the common voltage wirings comprise a plurality of first common voltage wirings spaced apart from each other along the second direction and at least one second common voltage wirings, each of the second common voltage wirings is parallel to the second direction, the at least two second common voltage wirings are spaced apart from each other along the first direction, each of the first common voltage wirings connects with the voltage transmission blocks arranged along the first direction, and the second common voltage wirings connect with the plurality of first common voltage wirings.

19. The LCD as claimed in claim 13, wherein each of the pixels comprises at least two pixel areas, and one of the pixel areas is configured with the voltage transmission block, and the voltage transmission blocks within the same pixel connect to the same first common voltage wirings.

20. The LCD as claimed in claim 13, wherein the voltage transmission block comprises a first TFT, gates of the first TFTs within the same pixel row, along the first direction, connect to the scanning line at the previous level corresponding to the pixels where the voltage transmission blocks are located, one of the source and the drain of the TFT connects to the pixel electrode within the pixel electrode of the pixel where the voltage transmission block is located, and the other one connects to the corresponding first common voltage wirings.
